(19) United States
(12) Patent Application Publication
(10) Pub. No.: US 2022/0113156 A1
(43) Pub. Date: Apr. 14, 2022

(54) METHOD, APPARATUS AND SYSTEM FOR GENERATING REAL SCENE MAP

(71) Applicant: Beijing Baidu Netcom Science Technology Co., Ltd., Beijing (CN)

(72) Inventors: Lingguang WANG, Beijing (CN); Guocai BAI, Beijing (CN); Jiankang XIN, Beijing (CN)

(21) Appl. No.: 17/560,818

(22) Filed: Dec. 23, 2021

(30) Foreign Application Priority Data
Jun. 30, 2021 (CN) 202110745439.7

(51) Int. Cl. G01C 21/36; G01C 21/30; G01C 21/00; G01C 21/34

(52) U.S. Cl. CPC G01C 21/3635; G01C 21/30; G01C 21/3863; G01C 21/343; G01C 21/3476; G01C 21/3804

(57) ABSTRACT

The present disclosure relates to a method, an apparatus and a system for generating a real scene map. The method includes: performing recognition on an acquired panorama image to obtain a target frame for each point of interest in the panorama image, where the target frame is used for selecting a point of interest through a frame, and the target frame has a position attribute, determining relative position information of each target frame with respect to the panorama image according to the position attribute of each target frame, and embedding each target frame into a preset sphere model according to the relative position information of each target frame with respect to the panorama image to obtain a panorama sphere model, and rendering the panorama sphere model to obtain a real scene map.

### CROSS-REFERENCE TO RELATED APPLICATION

This application claims priority to Chinese Patent Application No. 202110745439.7, filed on Jun. 30, 2021, which is hereby incorporated by reference in its entirety.

### TECHNICAL FIELD

The present disclosure relates to the technical field of image processing and data processing, and specifically, to intelligent traffic and big data technologies, in particular to a method, an apparatus and a system for generating a real scene map, which can be applied to the fields of autonomous driving and autonomous parking.

### BACKGROUND

With a development of electronic map technology, an electronic map includes a real scene map that supports 360-degree real scene display, that is, a real scene map is an electronic map where a 360-degree real street view can be seen.

In related art, a commonly used method for generating a real scene map includes: carrying a point cloud device by an acquisition vehicle, acquiring point cloud data by the point cloud device when the acquisition vehicle is driving, where the point cloud data includes coordinates of each sampling point, sending the acquired point cloud data to a server by the point cloud device, performing data processing such as aggregation and analysis according to the point cloud data by the server, loading information obtained after the data processing to a preset sphere model, thereby drawing to obtain a real scene map.

However, by adopting the above method, in an aspect, the cost of a hardware device used for supporting to obtain a real scene map is relatively high, and in another aspect, data processing such as aggregation and analysis is difficult and has a high deviation.

### SUMMARY

The present disclosure provides a method, an apparatus and a system for generating a real scene map for reducing the cost.

According to a first aspect of the present disclosure, a method for generating a real scene map is provided, including:

performing recognition on an acquired panorama image to obtain a target frame for each point of interest in the panorama image, where the target frame is used for selecting a point of interest through a frame, and the target frame has a position attribute;

determining relative position information of each target frame with respect to the panorama image according to the position attribute of each target frame, and embedding each target frame into a preset sphere model according to the relative position information of each target frame with respect to the panorama image to obtain a panorama sphere model; and

rendering the panorama sphere model to obtain a real scene map.

According to a second aspect of the present disclosure, an apparatus for generating a real scene map is provided, including:

a recognizing unit, configured to perform recognition on an acquired panorama image to obtain a target frame for each point of interest in the panorama image, where the target frame is used for selecting a point of interest through a frame, and the target frame has a position attribute;

a determining unit, configured to determine relative position information of each target frame with respect to the panorama image according to the position attribute of each target frame;

an embedding unit, configured to embed each target frame into a preset sphere model according to the relative position information of each target frame with respect to the panorama image to obtain a panorama sphere model; and

a rendering unit, configured to render the panorama sphere model to obtain a real scene map.

According to a third aspect of the present disclosure, an electronic device is provided, including:

at least one processor; and

a memory communicatively connected to the at least one processor; where,

the memory has instructions executable by the at least one processor stored thereon, and the instructions are executed by the at least one processor to cause the at least one processor to execute the method according to the first aspect.

According to a fourth aspect of the present disclosure, there is provided a non-transitory computer readable storage medium which has computer instructions stored thereon, where the computer instructions are used to cause a computer to execute the method according to the first aspect.

According to a fifth aspect of the present disclosure, there is provided a computer program product, and the computer program product includes: a computer program which is stored in a readable storage medium, at least one processor of an electronic device may read the computer program from the readable storage medium, and the at least one processor executes the computer program to cause the electronic device to perform the method according to the first aspect.

According to a sixth aspect of the present disclosure, there is provided a system for generating a real scene map, including: an image acquisition apparatus, and an apparatus according to the second aspect.

It should be understood that the content described in this section is not intended to identify key or critical features of embodiments of the present disclosure, and is not intended to limit a scope of the present disclosure. Other features of the present disclosure will be easily understood from the following description.

### BRIEF DESCRIPTION OF DRAWINGS

The accompanying drawings are used to better understand the present solution, and do not constitute a limitation to the present disclosure, where:

FIG. 1 is a schematic diagram according to a first embodiment of the present disclosure;

FIG. 2 is a schematic diagram according to a second embodiment of the present disclosure;

FIG. 3 is a schematic diagram of an effect of image-cutting processing according to an embodiment of the present disclosure;

FIG. 4 is a schematic diagram of a target frame according to an embodiment of the present disclosure;

FIG. 5 is a schematic diagram of a relative angle according to an embodiment of the present disclosure;

FIG. 6 is a schematic diagram of an embedding parameter according to an embodiment of the present disclosure;

FIG. 7 is a schematic diagram according to a third embodiment of the present disclosure;

FIG. 8 is a diagram of a scenario where a method for generating a real scene map according to an embodiment of the present disclosure may be implemented;

FIG. 9 is a schematic diagram according to a fourth embodiment of the present disclosure;

FIG. 10 is a schematic diagram according to a fifth embodiment of the present disclosure; and

FIG. 11 is a block diagram of an electronic device used for implementing a method for generating a real scene map according to an embodiment of the present disclosure.

### DETAILED DESCRIPTION OF EMBODIMENTS

Exemplary embodiments of the present disclosure are described below in combination with the accompanying drawings, where various details of embodiments of the present disclosure are included to facilitate understanding, and they should be considered as merely exemplary. Accordingly, a person of ordinary skill in the art will recognize that various changes and modifications can be made to the embodiments described herein without departing from a scope and spirit of the disclosure. Also, descriptions of well-known functions and structures are omitted in the following description for clarity and conciseness.

An electronic map is an essential life tool in people's life and work. Along with the development of traffic and tourism industry, in order to obtain a better experience of a map, more and more people choose to use a real scene map.

In a real scene map, people can roam on a virtual city street with a 360-degree field of view to view a scene of the street, which combines an excellent position query capability owned by an electronic map and a virtual reality experience provided by a panorama, and provides great convenience to people's daily life, travel and the like.

In related art, two methods are usually adopted to generate a real scene map, where one method is a position estimation method, and the other method is a point cloud estimation method.

Generating a real scene map by adopting the position estimation method mainly includes: acquiring location information of a point of interest (Point of Interest, POI), (for example, coordinates of a point of interest in a world coordinate system), and drawing a real scene map according to the location information of the point of interest.

However, the above method does not consider height of a surrounding building of a point of interest. A point of interest in a real scene map is likely to be blocked, causing the point of interest in the real scene map to be invisible, thereby resulting in a technical problem of low reliability of the real scene map.

Generating a real scene map by adopting the point cloud estimation method mainly includes: carrying a point cloud device by an acquisition vehicle, acquiring point cloud data by the point cloud device when the acquisition vehicle is driving, where the point cloud data includes coordinates of each sampling point, sending the acquired point cloud data to a server by the point cloud device, performing data processing such as aggregation and analysis according to the point cloud data by the server, loading information obtained after the data processing to a preset sphere model, thereby drawing to obtain a real scene map.

However, the above method needs to be implemented based on carrying a point cloud device by an acquisition vehicle, and therefore, requires higher-cost hardware to support, and the method needs to be implemented through data processing such as aggregation and analysis, and therefore, the cost and resource used for data processing is high, and it is easy to cause a high deviation due to a relatively large amount of point cloud data, and there is a technical problem of low efficiency of generating a real scene map caused by complex data processing process.

In order to solve at least one of the above technical problems, the inventors of the present disclosure obtains an inventive concept of the present disclosure through creative efforts: determining relative position information of a target frame with respect to a panorama image according to a position of the target frame of a point of interest in the panorama image, and embedding the target frame into a preset sphere model based on the relative position information to obtain a panorama sphere model, so as to render the panorama sphere model to obtain a real scene map.

Based on the above inventive concept, the present disclosure provides a method, an apparatus and a system for generating a real scene map, applied to the technical fields of image processing and data processing, and specifically, to intelligent traffic and big data technologies, which can be applied to the fields of autonomous driving and autonomous parking, so as to save resources, improve reliability of a real scene map, and meet a user requirement.

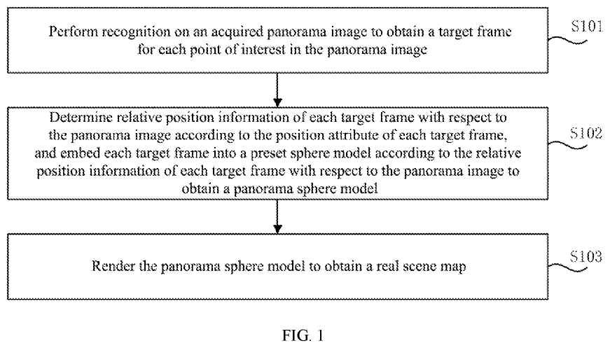

FIG. 1 is a schematic diagram according to a first embodiment of the present disclosure. As shown in FIG. 1, a method for generating a real scene map according to the embodiment of the present disclosure includes:

S101: perform recognition on an acquired panorama image to obtain a target frame for each point of interest in the panorama image.

The target frame is used for selecting a point of interest through a frame, and the target frame has a position attribute.

A point of interest may be understood as an object in a geographic information system, for example, a point of interest may be a house, a shop, a postbox, a bus station, etc.

Illustratively, an executive entity of this embodiment may be an apparatus for generating a real scene map (hereinafter referred to as generating apparatus), and the generating apparatus may be a server (including a local server and a cloud server, and the server may be a cloud control platform, a vehicle-road cooperative management platform, a central subsystem, an edge computing platform, a cloud computing platform, etc.), or may be a road side device, or may be a terminal device, or may be a processor, or may be a chip, or the like, which is not limited in this embodiment.

The road side device may be, for example, a road side sensing device with a computing function, a road side computing device connected to a road side sensing device. In a vehicle-road cooperative system architecture of intelligent traffic, the road side device includes a road side sensing device and a road side computing device. The road side sensing device (e.g., a road side camera) is connected to the road side computing device (e.g., a road side computing unit, RSCU), and the road side computing device is connected to a server, and the server may communicate with an autonomous driving or assisted driving vehicle in various manners; or a road side sensing device itself includes a computing function, thus the road side sensing device is directly connected to a server. The above connections may be wired or wireless.

With regard to the acquisition of a panorama image, the following example may be adopted for implementation:

In an example, the generating apparatus may be connected to an image acquisition apparatus and receive a panorama image sent by the image acquisition apparatus.

In another example, the generating apparatus may provide a tool for loading a panorama image, and a user may send a panorama image to the generating apparatus through the tool for loading a panorama image.

The tool for loading a panorama image may be an interface configured to connect with a peripheral device, such as an interface configured to connect with other storage devices, and a panorama image sent by the peripheral device is acquired through this interface. The tool for loading a panorama image may also be a display apparatus, for example, the generating apparatus may output an interface on the display apparatus where the interface is provided with a function of inputting and loading a panorama image, and a user may import a panorama image to the generating apparatus through this interface.

It should be noted that the above-mentioned examples are merely used for illustratively describing the embodiments of acquiring a panorama mage which can be adopted by this embodiment, however, cannot be interpreted as a limitation on the manner of acquiring a panorama image.

In some embodiments, an optical character recognition (Optical Character Recognition, OCR) technology may be used to perform recognition on a panorama image to obtain a target frame for each point of interest in the panorama image.

In some other embodiments, a recognition model for recognizing each target frame in a panorama image may also be pre-trained, and recognition is performed on the panorama image based on the trained recognition model, thereby obtaining the target frame for each point of interest in the panorama image.

Similarly, the above-mentioned examples are merely used for illustratively describing the embodiments of performing recognition on a panorama image which may be used by this embodiment, but cannot be interpreted as a limitation on the manner of performing recognition on a panorama image.

S102: determine relative position information of each target frame with respect to the panorama image according to the position attribute of each target frame, and embed each target frame into a preset sphere model according to the relative position information of each target frame with respect to the panorama image to obtain a panorama sphere model.

The preset sphere model and the panorama sphere model are relative concepts. The preset sphere model refers to a sphere model before respective target frames are embedded, and the panorama sphere model refers to a sphere model after respective target frames are embedded into the preset sphere model.

In this embodiment, a sphere model is introduced, and each target frame is embedded into a preset sphere model according to the relative position information of each target frame with respect to the panorama image to obtain a panorama sphere model including each target frame.

S103: render the panorama sphere model to obtain a real scene map.

Based on the above-mentioned analysis, it can be seen that the embodiment of the present disclosure provides a method for generating a real scene map, including: performing recognition on an acquired panorama image to obtain a target frame for each point of interest in the panorama image, where the target frame is used for selecting a point of interest through a frame, and the target frame has a position attribute; determining relative position information of each target frame with respect to the panorama image according to the position attribute of each target frame, and embedding each target frame into a preset sphere model according to the relative position information of each target frame with respect to the panorama image to obtain a panorama sphere model, and rendering the panorama sphere model to obtain a real scene map. In this embodiment, technical features of determining relative position information of each target frame with respect to the panorama image, and embedding each target frame into a preset sphere model according to the relative position information of each target frame with respect to the panorama image to obtain a panorama sphere model are introduced, so that a real scene map is generated based on rendering the panorama sphere model. In one aspect, a technical problem of low reliability of a real scene map resulting from the fact that a point of interest in a real scene map in the related art is likely to be blocked is avoided, and a technical effect of improving reliability and practicability of a real scene map is achieved. In another aspect, a technical problem of a high cost due to adopting a corresponding equipment (such as an acquisition vehicle and a point cloud device) in the related art is avoided, and a technical effect of saving resources and cost is achieved. In still another aspect, a technical problem of low accuracy and efficiency of the real scene map resulting from generating a real scene map based on complex data processing in the related art is avoided, and a technical effect of improving reliability and accuracy of a real scene map and improving efficiency of generating the real scene map is achieved.

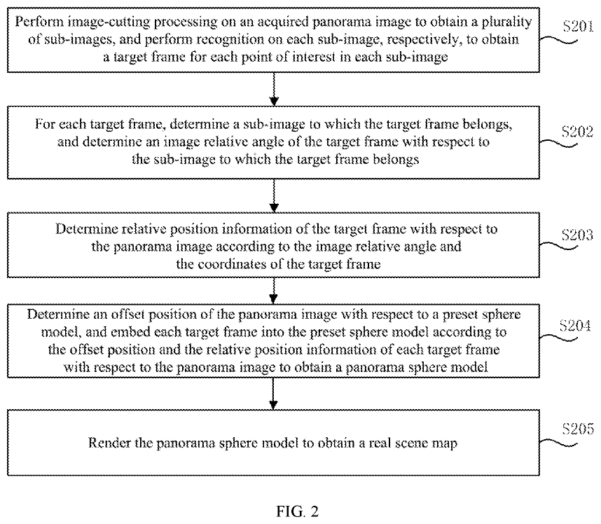

FIG. 2 is a schematic diagram according to a second embodiment of the present disclosure. As shown in FIG. 2, a method for generating a real scene map according to the embodiment of the present disclosure includes:

S201: perform image-cutting processing on an acquired panorama image to obtain a plurality of sub-images, and perform recognition on each sub-image, respectively, to obtain a target frame for each point of interest in each sub-image.

The target frame is used for selecting a point of interest through a frame, and the target frame has a position attribute.

Illustratively, with regard to an executive entity of the embodiment, acquisition of a panorama image, and an implementation principle of recognition on each sub-image, reference may be made to the first embodiment, details of which will not be repeatedly described herein.

The image-cutting processing may be interpreted as dividing the panorama image into a plurality of sub-images. For example, the image-cutting processing may be performed to the panorama image based on a preset angle to obtain a plurality of equally divided sub-images.

Preferably, tiling processing is performed to the sub-images obtained through the image-cutting processing, so that the sub-images to be recognized become tiled images, thereby facilitating the recognition on each sub-image by the generating apparatus, and improving accuracy and reliability of recognition, and reducing the recognition cost.

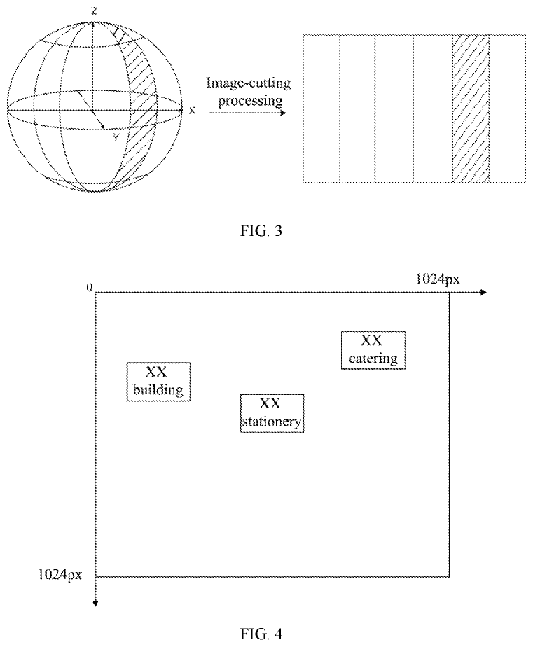

Illustratively, it can be seen from FIG. 3 that image-cutting processing may be performed to a panorama image on the left side of FIG. 3 with a preset angle of 60° to obtain six equally divided sub-images as shown on the right side of FIG. 3, and these six sub-images are tiled images.

X, Y and Z shown in FIG. 3 represent coordinate axes of the panorama image.

Surely, the generating apparatus may also perform the image-cutting processing to the panorama image with a preset angle of 90° to obtain 4 equally divided sub-images, and so on, which will not be listed herein one by one.

Illustratively, when the generating apparatus performs recognition on a shadow sub-image in the 6 sub-images as shown in FIG. 3, target frames as shown in FIG. 4 can be obtained.

3 points of interest of the shadow sub-image are obtained by the generating apparatus through performing recognition, which are respectively, “XX building”, “XX stationery” and “XX catering” as shown in FIG. 4, and accordingly, frames through which points of interest are selected respectively are target frames.

In FIG. 4, 1024 px (pixel) represents 1024 pixels, that is, in this embodiment, the image has 1024*1024 pixels. Accordingly, a position attribute of a target frame may be a pixel position of the target frame.

It should be noted that, in this embodiment, a plurality of sub-images are obtained through performing the image-cutting processing on the panorama image, which can facilitate recognition of the generating apparatus and reduce recognition interference, so that the recognition by the generating apparatus has a technical effect of high flexibility and accuracy.

S202: for each target frame, determine a sub-image to which the target frame belongs, and determine an image relative angle of the target frame with respect to the sub-image to which the target frame belongs.

In some embodiments, the belonging position information of the sub-image to which a target frame belongs in the panorama image may be determined in advance, and then an image relative angle is determined according to the belonging position information and coordinates of the target frame to determine the image relative angle through relative position conversion, thereby achieving a technical effect of flexibility and reliability of determining the image relative angle.

In some embodiments, the belonging position information includes: a field of view of the sub-image to which the target frame belongs with respect to a horizontal direction of the panorama image, and a field of view of the sub-image to which the target frame belongs with respect to a vertical direction of the panorama image; and the coordinates of the target frame include coordinates of diagonal points of the target frame.

The determination of the image relative angle according to the position information of the sub-image and the coordinates of the target frame, includes the following steps:

A first step: determine coordinates of a center point of the target frame according to the coordinates of the diagonal points of the target frame.

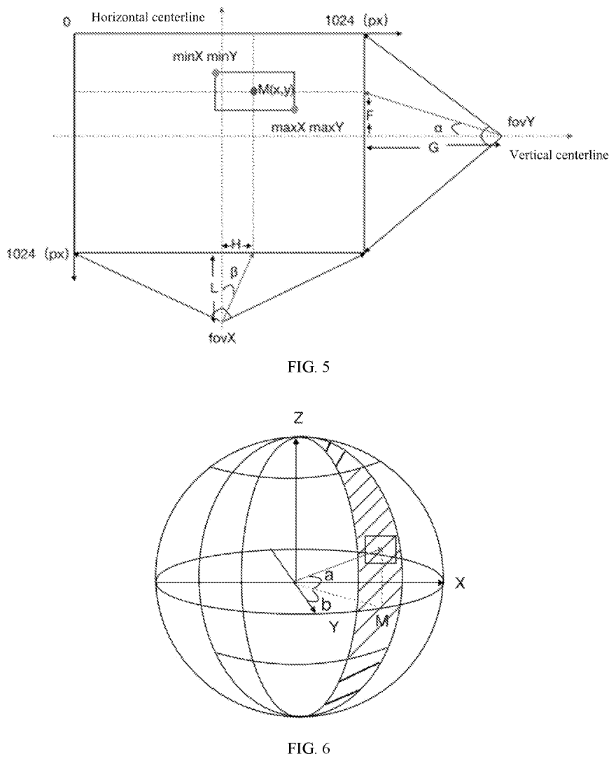

Illustratively, as shown in FIG. 5, an upper left corner point and a right lower corner point of the target frame are diagonal points, coordinates of the upper left corner point are (minX, minY), and coordinates of the lower right corner point are (maxX, maxY), and then the coordinates of the center point of the target frame can be calculated from (minX, minY) and (maxX, maxY).

For example, an abscissa of the center point=(maxX+minX)/2, and an ordinate of the center point=(maxY+minY)/2. Referring to FIG. 5, the center point is M, the coordinates of the center point M is (x, y), and x=(maxX+minX)/2, y=(maxY+minY)/2.

A second step: determine a horizontal relative angle of the target frame with respect to the sub-image to which the target frame belongs according to the coordinates of the center point and the field of view of the sub-image to which the target frame belongs with respect to the horizontal direction of the panorama image.

Referring to FIG. 5, a horizontal relative angle β may be determined by Equation 1:

$$β = arc tan ( H / L ) * 180 / π$$

where L=(1024/2)*tan((90−fovX/2)*π/180), fovX is the field of view of the sub-image to which the target frame belongs with respect to the horizontal direction of the panorama image; and

where H=(minX+maxX)/2−(1024/2).

A third step: determine a vertical relative angle of the target frame with respect to the sub-image to which the target frame belongs according to the coordinates of the center point and the field of view of the sub-image to which the target frame belongs with respect to the vertical direction of the panorama image, where the image relative angle includes the horizontal relative angle and the vertical relative angle.

Referring to FIG. 5, a vertical relative angle α may be determined by Formula 2:

$$β = arc tan ( F / G ) * 180 / π$$

where G=(1024/2)*tan((90−fovY/2)*π/180), fovY is the field of view of the sub-image to which the target frame belongs with respect to the vertical direction of the panorama image; and

where F=(minY+maxY)/2−(1024/2).

As shown in FIG. 5, the field of view of the sub-image to which the target frame belongs with respect to the horizontal direction of the panorama image may be interpreted as: a field of view of the sub-image to which the target frame belongs with respect to a horizontal centerline of the panorama image; and the field of view of the sub-image to which the target frame belongs with respect to the vertical direction of the panorama image may be interpreted as: a field of view of the sub-image to which the target frame belongs with respect to a vertical centerline of the panorama image.

Based on the above-mentioned manner, the image relative angle is determined, and a positional association relationship between the sub-image and the panorama image is sufficiently considered, and a technical effect of the image relative angle having high accuracy and reliability can be realized.

S203: determine relative position information of the target frame with respect to the panorama image according to the image relative angle and the coordinates of the target frame.

In combination with the above-mentioned analysis, the image relative angle includes the horizontal relative angle, and accordingly, the relative position information of the target frame with respect to the panorama image includes: a relative angle of the target frame with respect to the horizontal direction of the panorama image; and the image relative angle includes the vertical relative angle, and accordingly, the relative position information of the target frame with respect to the panorama image includes: a relative angle of the target frame with respect to the vertical direction of the panorama image.

It should be noted that, in this embodiment, determining the relative position information of the target frame with respect to the panorama image through the image relative angle in combination with the coordinates of the target frame, is equivalent to determining the relative position information of the target frame with respect to the panorama image through an association relationship between the target frame and the sub-image and an association relationship between the sub-image and the panorama image, and a technical effect of improving accuracy and reliability of the determined relative position information of the target frame with respect to the panorama image can be achieved through the compact association relationship.

S204, determine an offset position of the panorama image with respect to a preset sphere model, and embedding each target frame into the preset sphere model according to the offset position and the relative position information of each target frame with respect to the panorama image to obtain a panorama sphere model.

The preset sphere model may be set in a world coordinate system (or referred to as a geodetic coordinate system). Due to a reason of an image acquisition apparatus, there may be a deviation between the panorama image and the world coordinate system, however in this embodiment, the deviation (i.e., offset position) is determined in advance, and the panorama sphere model is obtained based on the deviation and the relative position information of the target frames with respect to the panorama image, and thus the effect of correcting deviation can be achieved, and thereby a technical effect of improving accuracy and reliability of the panorama sphere model can be achieved.

In some embodiments, an embedding parameter for embedding each target frame into the preset sphere model may be determined according to the offset position and the relative position information of each target frame with respect to the panorama image, and each target frame is embedded into the preset sphere model according to the embedding parameter corresponding to each target frame to obtain the panorama sphere model.

In some embodiments, the offset position includes: an included angle of the panorama image with respect to the preset sphere model, and a pitch angle when the panorama image is generated, and the determining the embedding parameter for embedding each target frame into the preset sphere model according to the offset position and the relative position information of each target frame with respect to the panorama image includes the following steps:

A first step: for each target frame, determine a horizontal angle for embedding the target frame into the preset sphere model according to the included angle of the panorama image with respect to the preset sphere model and the relative position information of the target frame with respect to the panorama image.

A second step: determine a vertical angle for embedding the target frame into the preset sphere model according to the pitch angle and the relative position information of the target frame with respect to the panorama image.

The embedded parameter includes the horizontal angle for embedding into the preset sphere model and the vertical angle for embedding into the preset sphere model.

Specifically, in combination with the above-mentioned example, if the preset sphere model is set based on a world coordinate system, a north direction of the preset sphere model may serve as a basis to determine the included angle of the panorama image with respect to the preset sphere model. The pitch angle may be understood as a pitch angle when an image acquisition apparatus acquires the panorama image.

The embedding parameter is determined from the included angle of the panorama image with respect to the preset sphere model in combination with the pitch angle, and thus, the embedding parameter can be caused to have high reliability, and then accuracy and reliability of the panorama sphere model can be improved when the target frame is embedded into the preset sphere model based on the embedding parameter, and then a technical effect of improving accuracy and reliability of the panorama map is achieved.

Illustratively, a horizontal angle b for embedding a target frame to a preset sphere model=a relative angle of the target frame with respect to a horizontal direction of a panorama image+an included angle of the panorama image with respect to the preset sphere model; a vertical angle a for embedding the target frame to the preset sphere model=a relative angle of the target frame with respect to the horizontal direction of the panorama image+a pitch angle, and a schematic diagram can refer to FIG. 6.

S205: render the panorama sphere model to obtain a real scene map.

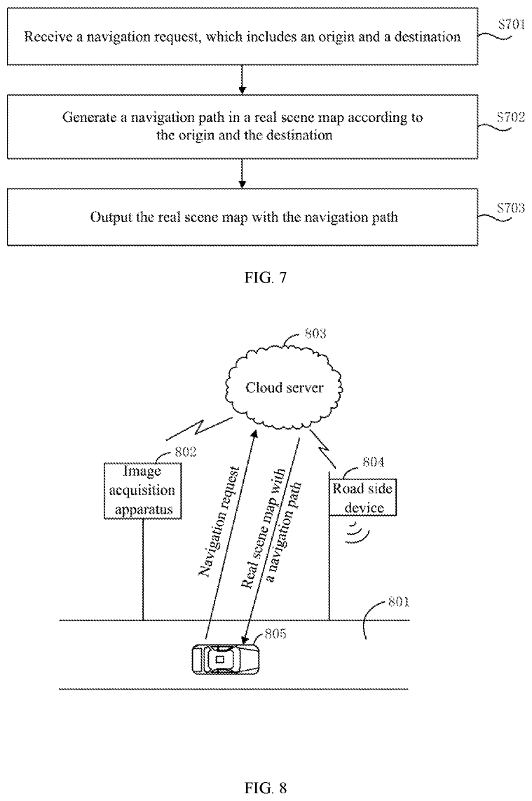

FIG. 7 is a schematic diagram according to a third embodiment of the present disclosure. As shown in FIG. 7, a method for generating a real scene map according to the embodiment of the present disclosure includes:

S701: receive a navigation request, which includes an origin and a destination.

It should be noted that, an executive entity of this embodiment may be the same as the executive entity of the first embodiment, or may be different from the executive entity of the first embodiment. That is, navigation based on a real scene map may be performed by the executive entity that generates the real scene map; or navigation is accomplished based on a real scene map by an executive entity for navigation after the real scene map is generated by an executive entity that generates the real scene map, which is not limited in this embodiment.

S702: generate a navigation path in a real scene map according to the origin and the destination, where the navigation path is used for representing a driving route from the origin to the destination.

The real scene map is generated based on the above-mentioned first embodiment or the second embodiment.

Illustratively, it is possible to determine the origin and the destination in the real scene map and plan to obtain a driving route starting from the origin and ending at the destination.

S703: output the real scene map with the navigation path.

In combination with the above-mentioned analysis, there are two manners of outputting the real scene map with the navigation path, one of which is to display the real scene map with the navigation path on the executive entity, while the other is to send the real scene map with the navigation path by the executive entity to a terminal device which sends the navigation request.

It is worth being noted that, it can be seen based on the above-mentioned analysis that, the real scene map provided by this embodiment has high accuracy and reliability, and therefore, when a navigation path is generated based on a real scene map with higher accuracy and reliability, the navigation path can thus have high accuracy and reliability, and thereby, accuracy and reliability of navigation can be achieved.

Now, an executive entity of generating a panorama map and an executive entity of applying the panorama map being different executive entities is illustratively described as an example with reference to an application scenario shown in FIG. 8.

As shown in FIG. 8, at least one side of a road 801 is provided with an image acquisition apparatus 802, and the image acquisition apparatus 802 is configured to acquire a panorama image, and transmit the panorama image to a cloud server 803.

The cloud server 803 executes a method for generating a real scene map provided by the embodiment to generate a real scene map, and transmits the real scene map to a road side device 804 arranged on at least one side of the road 801.

A vehicle 805 travelling on the road 801 may access the road side device 804 and may send a navigation request to the road side device 804.

The road side device 804 generates a navigation path in the real scene map according to the navigation request, and sends the real scene map with the navigation path to the vehicle 805.

The vehicle 805 implements navigation based on the real scene map with the navigation path.

It should be noted that, the above-mentioned examples are merely used for illustratively describing an application scenario which the embodiment may be applicable to, and an executive entity which may be involved, and should not be interpreted as a limitation to the application scenario and the executive entity of this embodiment.

For example, in an example, a real scene map may be generated by a road side device; in another example, a vehicle may access a cloud server, send a navigation request to the cloud server, and receive a real scene map with a navigation path fed back by the cloud server; and in still another example, a vehicle may access a cloud server, and the cloud server delivers a real scene map to the vehicle, and the vehicle may output a real scene map with a navigation path based on the real scene map, and so on, which will not be listed one by one here.

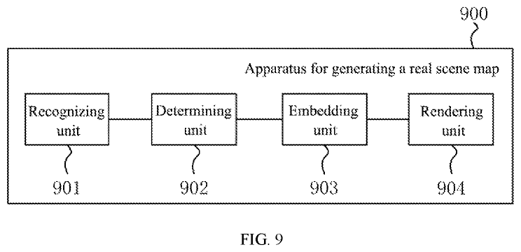

FIG. 9 is a schematic diagram according to a fourth embodiment of the present disclosure. As shown in FIG. 9, an apparatus for generating a real scene map 900 according to the embodiment of the present disclosure includes:

a recognizing unit 901, configured to perform recognition on an acquired panorama image to obtain a target frame for each point of interest in the panorama image, where the target frame is used for selecting a point of interest through a frame, and the target frame has a position attribute;

a determining unit 902, configured to determine relative position information of each target frame with respect to the panorama image according to the position attribute of each target frame;

an embedding unit 903, configured to embed each target frame into a preset sphere model according to the relative position information of each target frame with respect to the panorama image to obtain a panorama sphere model; and

a rendering unit 904, configured to render the panorama sphere model to obtain a real scene map.

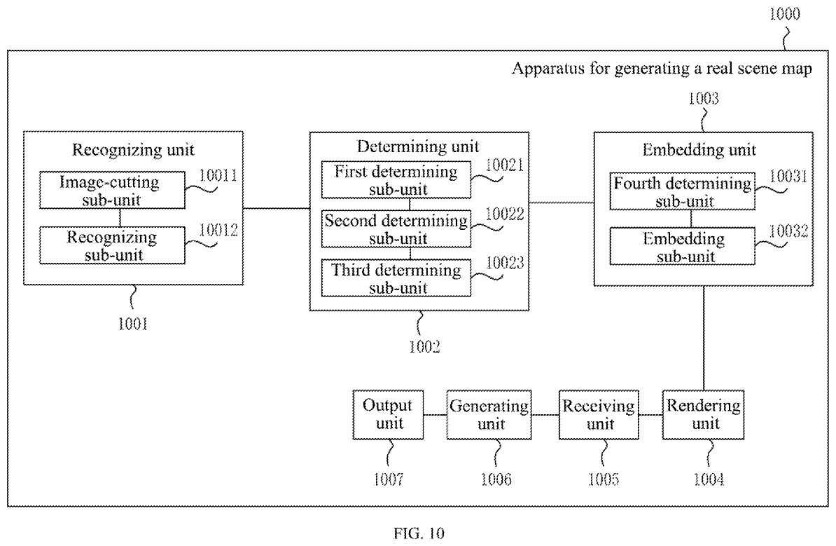

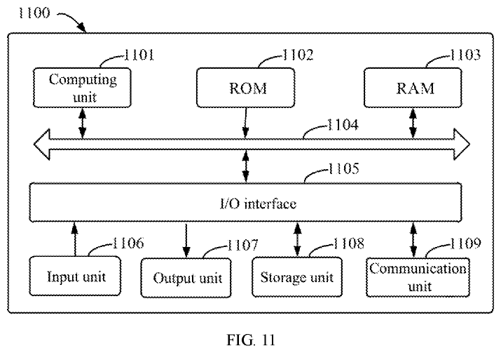

FIG. 10 is a schematic diagram according to a fifth embodiment of the present disclosure. As shown in FIG. 10, an apparatus for generating a real scene map 1000 according to the embodiment of the present disclosure includes:

A recognizing unit 1001, configured to perform recognition on an acquired panorama image to obtain a target frame for each point of interest in the panorama image, where the target frame is used for selecting a point of interest through a frame, and the target frame has a position attribute.

Referring to FIG. 10, it can be seen that, in some embodiments, the recognizing unit 1001 includes:

an image cutting sub-unit 10011, configured to perform image-cutting processing on the panorama image to obtain a plurality of sub-images; and

a recognizing sub-unit 10012, configured to perform recognition on each sub-image to obtain a target frame for each point of interest in each sub-image.

A determining unit 1002, configured to determine relative position information of each target frame with respect to the panorama image according to the position attribute of each target frame.

Referring to FIG. 10, it can be seen that, in some embodiments, a panorama image includes a plurality of sub-images, the position attribute of the target frame includes coordinates of the target frame, and the determining unit 1002 includes:

a first determining sub-unit 10021, configured to determine, for each target frame, a sub-image to which the target frame belongs; and

a second determining sub-unit 10022, configured to determine an image relative angle of the target frame with respect to the sub-image to which the target frame belongs.

In some embodiments, the second determining sub-unit 10022 is configured to determine belonging position information of the sub-image to which the target frame belongs in the panorama image, and determine the image relative angle according to the belonging position information and the coordinates of the target frame.

In some embodiments, the belonging position information includes: a field of view of the sub-image to which the target frame belongs with respect to a horizontal direction of the panorama image, and a field of view of the sub-image to which the target frame belongs with respect to a vertical direction of the panorama image; and the coordinates of the target frame include coordinates of diagonal points of the target frame. The second determining sub-unit 10022 is configured to determine coordinates of a center point of the target frame according to the coordinates of the diagonal points of the target frame, determine a horizontal relative angle of the target frame with respect to the sub-image to which the target frame belongs according to the coordinates of the center point and the field of view of the sub-image to which the target frame belongs with respect to the horizontal direction of the panorama image, and determine a vertical relative angle of the target frame with respect to the sub-image to which the target frame belongs according to the coordinates of the center point and the field of view of the sub-image to which the target frame belongs with respect to the vertical direction of the panorama image, where the image relative angel includes the horizontal relative angle and the vertical relative angle.

A third determining sub-unit 10023, configured to determine the relative position information of the target frame with respect to the panorama image according to the image relative angle and the coordinates of the target frame.

An embedding unit 1003, configured to embed each target frame into a preset sphere model according to the relative position information of each target frame with respect to the panorama image to obtain a panorama sphere model.

Referring to FIG. 10, it can be seen that, in some embodiments, the embedding unit 1003 includes:

a fourth determining sub-unit 10031, configured to determine an offset position of the panorama image with respect to the preset sphere model; and

an embedding sub-unit 10032, configured to embed each target frame into the preset sphere model according to the offset position and the relative position information of each target frame with respect to the panorama image to obtain the panorama sphere model.

In some embodiments, the embedding sub-unit 10032 is configured to, determine, according to the offset position and the relative position information of each target frame with respect to the panorama image, an embedding parameter for embedding each target frame into the preset sphere model and embed each target frame into the preset sphere model according to the embedding parameter corresponding to each target frame to obtain the panorama sphere model.

In some embodiments, the offset position includes: an included angle of the panorama image with respect to the preset sphere model, and a pitch angle when the panorama image is generated; the embedding sub-unit 10032 is configured to, for each target frame, determine a horizontal angle for embedding the target frame into the preset sphere model according to the included angle of the panorama image with respect to the preset sphere model and the relative position information of the target frame with respect to the panorama image, and determine a vertical angle for embedding the target frame into the preset sphere model according to the pitch angle and the relative position information of the target frame with respect to the panorama image, where the embedded parameter includes the horizontal angle for embedding into the preset sphere model and the vertical angle for embedding into the preset sphere model.

A rendering unit 1004, configured to render the panorama sphere model to obtain a real scene map.

A receiving unit 1005, configured to receive a navigation request, where the navigation request includes an origin and a destination.

A generating unit 1006, configured to generate a navigation path in the real scene map according to the origin and the destination, where the navigation path is used for representing a driving route from the origin to the destination.

An output unit 1007, configured to output the real scene map with the navigation path.

According to an embodiment of the present disclosure, the present disclosure further provides an electronic device and a readable storage medium.

According to an embodiment of the present disclosure, the present disclosure further provides a computer program product, where the computer program product includes: a computer program which is stored in a readable storage medium, at least one processor of an electronic device may read the computer program from the readable storage medium, and the at least one processor executes the computer program to cause the electronic device to perform a solution provided by any of the above-mentioned embodiments.

FIG. 11 shows a schematic block diagram of an example electronic device 1100 which may be used to implement an embodiment of the present disclosure. The electronic device is intended to represent various forms of digital computers, such as a laptop computer, a desktop computer, a workstation, a personal digital assistant, a server, a blade server, a mainframe computer, and other suitable computers. The electronic device may also represent various forms of mobile apparatuses, such as a personal digital assistant, a cellular telephone, a smart phone, a wearable device, and other similar computing apparatuses. The components shown herein, their connections and relationships, and their functions are merely examples and are not intended to limit implementations of the present disclosure described and/or claimed herein.

As shown in FIG. 11, the electronic device 1100 includes a computing unit 1101, which can execute various appropriate actions and processing according to a computer program stored in a read only memory (ROM) 1102 or a computer program loaded into a random access memory (RAM) 1103 from a storage unit 1108. In the RAM 1103, there may further stored various programs and data required for operation of the device 1100. The computing unit 1101, the ROM 1102, and the RAM 1103 are connected to each other through a bus 1104. An input/output (I/O) interface 1105 is also connected to the bus 1104.

Multiple components in the device 1100 are connected to the I/O interface 1105, including: an input unit 1106, such as a keyboard, a mouse, etc.; an output unit 1107, for example, various types of displayers, speakers, etc.; a storage unit 1108, for example, a magnetic disk, an optical disk, etc.; and a communication unit 1109, such as a network card, a modem, a wireless communication transceiver, etc. The communication unit 1109 allows the device 1100 to exchange information/data with other devices through a computer network such as the Internet and/or various telecommunication networks.

The computing unit 1101 may be a variety of general purpose and/or special purpose processing components with capabilities of processing and computing. Some examples of the computing unit 1101 include, but are not limited to, a central processing unit (CPU), a graphics processing unit (GPU), various specialized artificial intelligence (AI) computing chips, various computing units for running machine learning model algorithms, a digital signal processor (DSP), and any suitable processor, controller, microcontroller, or the like. The computing unit 1101 performs various methods and processes described above, for example, the method for generating a real scene map. For example, in some embodiments, the method of generating a real scene map may be implemented as a computer software program, which is tangibly embodied on a machine readable medium, for example, the storage unit 1108. In some embodiments, part or all of a computer program may be loaded and/or installed to the device 1100 via the ROM 1102 and/or the communication unit 1109. When the computer program is loaded to the RAM 1103 and executed by the computing unit 1101, one or more steps of the method for generating a real scene map described above may be performed. Alternatively, in some other embodiments, the computing unit 1101 may be configured to perform the method for generating a real scene map through any other suitable manners (e.g., by means of firmware).

Various implementation manners of the systems and technologies described above herein may be implemented in a digital electronic circuitry system, an integrated circuit system, a field programmable gate array (FPGA), an application specific integrated circuit (ASIC), an application specific standard product (ASSP), a system-on-chip system (SOC), a load programmable logic device (CPLD), computer hardware, firmware, software, and/or a combination thereof These various implementation manners may include: implemented in one or more computer programs, where the one or more computer programs may be executed and/or interpreted on a programmable system which includes at least one programmable processor, this programmable processor may be a special purpose or general purpose programmable processor, and may receive data and instructions from a storage system, at least one input apparatus, and at least one output apparatus, and transmit data and instructions to the storage system, the at least one input apparatus, and the at least one output apparatus.

Program code for implementing the method of the present disclosure may be written in any combination of one or more programming languages. The program code may be provided to a processor or a controller of a general purpose computer, a special purpose computer, or other programmable data processing apparatus, so that functions/operations specified in the flowchart diagrams and/or block diagrams are implemented when the program code is executed by the processor or controller. The program code may be executed entirely on a machine, executed partly on a machine, executed partly on a machine and partly on a remote machine as independent software packages, or entirely on a remote machine or server.

In context of the present disclosure, a machine readable medium may be a tangible medium which may contain or store a program to be used by an instruction execution system, apparatus, or device, or to be used in connection with an instruction execution system, apparatus, or device. The machine readable medium may be a machine readable signal medium or a machine readable storage medium. The machine readable medium may include, but is not limited to, an electronic, magnetic, optical, electromagnetic, infrared, or semiconductor system, apparatus, or device, or any suitable combination of the above-mentioned content. More specific examples of a machine readable storage medium may include an electrical connection based on one or more lines, a portable computer disk, a hard disk, a random access memory (RAM), a read only memory (ROM), an erasable programmable read only memory (EPROM or flash memory), an optical fiber, a portable compact disc read only memory (CD-ROM), an optical storage device, a magnetic storage device, or any suitable combination of the above-mentioned content.

To provide interaction with a user, systems and techniques described here may be implemented on a computer, and the computer has: a display apparatus (e.g., a CRT (cathode ray tube) or LCD (liquid crystal display) monitor) for displaying information to a user; and a keyboard and a pointing apparatus (e.g., a mouse or trackball) through which a user can provide input to the computer. Other types of apparatuses may further be used to provide interaction with a user; for example, feedback provided to a user may be any form of sensory feedback (e.g., visual feedback, auditory feedback, or tactile feedback); and input from a user may be received in any form (including sound input, voice input, or tactile input).

The systems and techniques described here may be implemented in a computing system (e.g., as a data server) that includes a back-end component, or a computing system (e.g., an application server) that includes a middleware component, or a computing system (e.g., a user computer having a graphical user interface or web browser, a user may interact with implementations of the systems and techniques described here through the graphical user interface or the web browser) including a front-end component, or a computing system including any combination of the back-end component, middleware component, or front-end component. Components of a system may be interconnected through any form or medium of digital data communication (e.g., a communication network). Examples of the communication network include: a local area network (LAN), a wide area network (WAN), and the Internet.

The computer system may include a client and a server. The client and server are generally remote from each other and typically interact through a communication network. A relationship of the client and the server is generated by computer programs running on corresponding computers and having a client-server relationship to each other.

The server may be a cloud server, also referred to as a cloud computing server or a cloud host, and is a host product in a cloud computing service system, to solve a defect of large management difficulty and weak service scalability in a traditional physical host and a VPS service (“Virtual Private Service Server”, or simply referred to as “VPS”). The server may also be a server of a distributed system, or a server incorporating a blockchain.

According to another aspect of the embodiments of the present disclosure, an embodiment of the present disclosure further provides a system for generating a real scene map, including: an image acquisition apparatus, and an apparatus for generating a real scene map as described by any of the above embodiments.

It should be understood that, steps may be reordered, added, or deleted using various forms of flows shown above. For example, steps recited in the present application may be executed in parallel or sequentially, or in a different order, as long as a desired result of a technical solution provided by the present disclosure can be achieved, which is not limited herein.

The above-mentioned detailed implementation manners do not constitute a limitation to a protection scope of the present disclosure. It should be appreciated by a person skilled in the art that, various modifications, combinations, sub-combinations and substitutions may be made according to design requirements and other factors. Any modifications, equivalent substitutions, improvements and the like made within a spirit and principle of the present disclosure shall fall within the protection scope of the present disclosure.

What is claimed is:

1. A method for generating a real scene map, comprising:
performing recognition on an acquired panorama image to obtain a target frame for each point of interest in the panorama image, wherein the target frame is used for selecting a point of interest through a frame, and the target frame has a position attribute;
determining relative position information of each target frame with respect to the panorama image according to the position attribute of each target frame, and embedding each target frame into a preset sphere model according to the relative position information of each target frame with respect to the panorama image to obtain a panorama sphere model; and
rendering the panorama sphere model to obtain a real scene map.

2. The method according to claim 1, wherein the panorama image comprises a plurality of sub-images, and the position attribute of the target frame comprises coordinates of the target frame; and determining the relative position information of each target frame with respect to the panorama image according to the position attribute of each the target frame comprises:
for each target frame, determining a sub-image to which the target frame belongs, and determining an image relative angle of the target frame with respect to the sub-image to which the target frame belongs; and
determining the relative position information of the target frame with respect to the panorama image according to the image relative angle and the coordinates of the target frame.

3. The method according to claim 2, wherein determining the image relative angle of the target frame with respect to the sub-image to which the target frame belongs comprises:
determining belonging position information of the sub-image to which the target frame belongs in the panorama image, and determining the image relative angle according to the belonging position information and the coordinates of the target frame.

4. The method according to claim 3, wherein the belonging position information comprises: a field of view of the sub-image to which the target frame belongs with respect to a horizontal direction of the panorama image, and a field of view of the sub-image to which the target frame belongs with respect to a vertical direction of the panorama image; and the coordinates of the target frame comprise coordinates of diagonal points of the target frame;
and determining the image relative angle according to the belonging position information and the coordinates of the target frame comprises:
determining coordinates of a center point of the target frame according to the coordinates of the diagonal points of the target frame;
determining a horizontal relative angle of the target frame with respect to the sub-image to which the target frame belongs according to the coordinates of the center point and the field of view of the sub-image to which the target frame belongs with respect to the horizontal direction of the panorama image; and
determining a vertical relative angle of the target frame with respect to the sub-image to which the target frame belongs according to the coordinates of the center point and the field of view of the sub-image to which the target frame belongs with respect to the vertical direction of the panorama image, wherein the image relative angle comprises the horizontal relative angle and the vertical relative angle.

5. The method according to claim 1, wherein embedding each target frame into the preset sphere model according to the relative position information of each target frame with respect to the panorama image to obtain the panorama sphere model comprises:
determining an offset position of the panorama image with respect to the preset sphere model; and
embedding each target frame into the preset sphere model according to the offset position and the relative position information of each target frame with respect to the panorama to obtain the panorama sphere model.

6. The method according to claim 2, wherein embedding each target frame into the preset sphere model according to the relative position information of each target frame with respect to the panorama image to obtain the panorama sphere model comprises:
determining an offset position of the panorama image with respect to the preset sphere model; and
embedding each target frame into the preset sphere model according to the offset position and the relative position information of each target frame with respect to the panorama to obtain the panorama sphere model.

7. The method according to claim 3, wherein embedding each target frame into the preset sphere model according to the relative position information of each target frame with respect to the panorama image to obtain the panorama sphere model comprises:
determining an offset position of the panorama image with respect to the preset sphere model; and
embedding each target frame into the preset sphere model according to the offset position and the relative position information of each target frame with respect to the panorama to obtain the panorama sphere model.

8. The method according to claim 4, wherein embedding each target frame into the preset sphere model according to the relative position information of each target frame with respect to the panorama image to obtain the panorama sphere model comprises:
determining an offset position of the panorama image with respect to the preset sphere model; and
embedding each target frame into the preset sphere model according to the offset position and the relative position information of each target frame with respect to the panorama to obtain the panorama sphere model.

9. The method according to claim 5, wherein embedding each target frame into the preset sphere model according to the offset position and the relative position information of each target frame with respect to the panorama to obtain the panorama sphere model comprises:
determining, according to the offset position and the relative position information of each target frame with respect to the panorama image, an embedding parameter for embedding each target frame into the preset sphere model; and
embedding each target frame into the preset sphere model according to the embedding parameter corresponding to each target frame to obtain the panorama sphere model.

10. The method according to claim 6, wherein embedding each target frame into the preset sphere model according to the offset position and the relative position information of each target frame with respect to the panorama to obtain the panorama sphere model comprises:
determining, according to the offset position and the relative position information of each target frame with respect to the panorama image, an embedding parameter for embedding each target frame into the preset sphere model; and
embedding each target frame into the preset sphere model according to the embedding parameter corresponding to each target frame to obtain the panorama sphere model.

11. The method according to claim 7, wherein embedding each target frame into the preset sphere model according to the offset position and the relative position information of each target frame with respect to the panorama to obtain the panorama sphere model comprises:
determining, according to the offset position and the relative position information of each target frame with respect to the panorama image, an embedding parameter for embedding each target frame into the preset sphere model; and
embedding each target frame into the preset sphere model according to the embedding parameter corresponding to each target frame to obtain the panorama sphere model.

12. The method according to claim 8, wherein embedding each target frame into the preset sphere model according to the offset position and the relative position information of each target frame with respect to the panorama to obtain the panorama sphere model comprises:
determining, according to the offset position and the relative position information of each target frame with respect to the panorama image, an embedding parameter for embedding each target frame into the preset sphere model; and
embedding each target frame into the preset sphere model according to the embedding parameter corresponding to each target frame to obtain the panorama sphere model.

13. The method according to claim 9, wherein the offset position comprises: an included angle of the panorama image with respect to the preset sphere model, and a pitch angle when the panorama image is generated; and determining the embedding parameter for embedding each target frame into the preset sphere model according to the offset position and the relative position information of each target frame with respect to the panorama image comprises:
for each the target frame, determining, according to the included angle of the panorama image with respect to the preset sphere model and the relative position information of the target frame with respect to the panorama image, a horizontal angle for embedding the target frame into the preset sphere model; and
determining, according to the pitch angle and the relative position information of the target frame with respect to the panorama image, a vertical angle for embedding the target frame into the preset sphere model, wherein the embedding parameter comprises the horizontal angle for embedding into the preset sphere model and the vertical angle for embedding into the preset sphere model.

14. The method according to claim 10, wherein the offset position comprises: an included angle of the panorama image with respect to the preset sphere model, and a pitch angle when the panorama image is generated; and determining the embedding parameter for embedding each target frame into the preset sphere model according to the offset position and the relative position information of each target frame with respect to the panorama image comprises:
for each the target frame, determining, according to the included angle of the panorama image with respect to the preset sphere model and the relative position information of the target frame with respect to the panorama image, a horizontal angle for embedding the target frame into the preset sphere model; and
determining, according to the pitch angle and the relative position information of the target frame with respect to the panorama image, a vertical angle for embedding the target frame into the preset sphere model, wherein the embedding parameter comprises the horizontal angle for embedding into the preset sphere model and the vertical angle for embedding into the preset sphere model.

15. The method according to claim 11, wherein the offset position comprises: an included angle of the panorama image with respect to the preset sphere model, and a pitch angle when the panorama image is generated; and determining the embedding parameter for embedding each target frame into the preset sphere model according to the offset position and the relative position information of each target frame with respect to the panorama image comprises:
for each the target frame, determining, according to the included angle of the panorama image with respect to the preset sphere model and the relative position information of the target frame with respect to the panorama image, a horizontal angle for embedding the target frame into the preset sphere model; and
determining, according to the pitch angle and the relative position information of the target frame with respect to the panorama image, a vertical angle for embedding the target frame into the preset sphere model, wherein the embedding parameter comprises the horizontal angle for embedding into the preset sphere model and the vertical angle for embedding into the preset sphere model.

16. The method according to claim 1, wherein performing recognition on the acquired panorama image to obtain the target frame for each point of interest in the panorama image comprises:
performing image-cutting processing to the panorama image to obtain a plurality of sub-images, and performing recognition on each of the sub-images, respectively, to obtain a target frame for each point of interest in each of the sub-images.

17. The method according to claim 1, further comprising:
receiving a navigation request, wherein the navigation request comprises an origin and a destination;
generating a navigation path in the real scene map according to the origin and the destination, wherein the navigation path is used for representing a driving route from the origin to the destination; and
outputting the real scene map with the navigation path.

18. An apparatus for generating a real scene map, comprising:
at least one processor; and
a memory communicatively connected to the at least one processor; wherein,
the memory has instructions executable by the at least one processor stored thereon, and the instructions are executed by the at least one processor to cause the at least one processor to:
perform recognition on an acquired panorama image to obtain a target frame for each point of interest in the panorama image, wherein the target frame is used for selecting a point of interest through a frame, and the target frame has a position attribute;
determine relative position information of each target frame with respect to the panorama image according to the position attribute of each target frame;
embed each target frame into a preset sphere model according to the relative position information of each target frame with respect to the panorama image to obtain a panorama sphere model; and
render the panorama sphere model to obtain a real scene map.

19. A non-transitory computer readable storage medium having computer instructions stored thereon, wherein the computer instructions are used for causing a computer to:
perform recognition on an acquired panorama image to obtain a target frame for each point of interest in the panorama image, wherein the target frame is used for selecting a point of interest through a frame, and the target frame has a position attribute;
determine relative position information of each target frame with respect to the panorama image according to the position attribute of each target frame, and embed each target frame into a preset sphere model according to the relative position information of each target frame with respect to the panorama image to obtain a panorama sphere model; and
render the panorama sphere model to obtain a real scene map.

20. A system for generating a real scene map, comprising: an image acquisition apparatus, and an apparatus according to claim 18.
